(19) United States
(12) Patent Application Publication
(10) Pub. No.: US 2007/0153534 A1
(43) Pub. Date: Jul. 5, 2007

(54) Selectively Adjustable Light Fixtures and Furniture

(75) Inventors: Edward Levy, Centennial, CO (US); Campbell Levy, Centennial, CO (US)

Correspondence Address: SHERIDAN ROSS PC, 1560 BROADWAY, SUITE 1200, DENVER, CO, 80202, US

(73) Assignee: CAMPBELL LEVY DESIGNS LLC, Englewood, CO (US)

(21) Appl. No.: 11/620,013

(22) Filed: Jan. 4, 2007

Related U.S. Application Data
(63) Continuation-in-part of application No. 29/248,710, filed on Aug. 29, 2006.
(63) Continuation-in-part of application No. 29/248,340, filed on Aug. 10, 2006.
(63) Continuation-in-part of application No. 29/247,350, filed on Jun. 13, 2006.
(63) Continuation-in-part of application No. 29/248,708, filed on Aug. 29, 2006.
(63) Continuation-in-part of application No. 29/248,709, filed on Aug. 29, 2006.
(63) Continuation-in-part of application No. 29/248,281, filed on Aug. 7, 2006.
(63) Continuation-in-part of application No. 29/247,352, filed on Jun. 13, 2006.
(63) Continuation-in-part of application No. 29/248,092, filed on Jul. 27, 2006.
(63) Continuation-in-part of application No. 29/248,093, filed on Jul. 27, 2006.
(60) Provisional application No. 60/756,292, filed on Jan. 4, 2006.

(51) Int. Cl. F21S 8/08

(52) U.S. Cl. 362/414; 362/410

(57) ABSTRACT

A selectively adjustable lighting device is provided that includes an automobile component that may include a plurality of selectively adjustable components operably interconnected thereto. In addition, electrical wires associated with a light fixture interconnected to the automobile component may be concealed, thereby enhancing the aesthetics of the lighting device.

This patent application claims the benefit of U.S. Provisional Patent Application Ser. No. 60/756,292, filed Jan. 4, 2006, which is incorporated by reference in its entirety herein. This application is also a Continuation-In-Part of U.S. Design patent application Ser. Nos. 29/248,710, 29/248,340, 29/247,350, 29/248,708, 29/248,709, 29/248,281, 29/247,352, 29/248,092 and 29/248,093, filed Aug. 29, 2006, Aug. 10, 2006, Jun. 13, 2006, Aug. 29, 2006, Aug. 29, 2006, Aug. 7, 2006, Jun. 13, 2006, Jul. 27, 2006 and Jul. 27, 2006, respectively, each of which are incorporated by reference in their entirety herein.

### FIELD OF THE INVENTION

The present invention generally relates to lighting fixtures and furniture at least partially comprised of automobile components. More specifically, one embodiment of the present invention employs an automobile crankshaft as a lamp body with at least one selectively adjustable component interconnected thereto to thus provide a dynamic sculptural element that may be selectively altered to the taste of the user.

### BACKGROUND OF THE INVENTION

Table lamps are well known but have one major drawback in that they are generally static displays. More specifically, it is often desirable to provide a lamp that includes a variety of selectively adjustable members, thereby allowing the user to alter the lamp to fit his or her personal taste. The main body of lamps may be made out of many different items, such as sculptures, and lamps of the prior art have often included a body made of an automobile component. However, these lamps generally must include wires to feed power to the light bulbs that are often exposed thereby making the lamp less appealing. Thus it is a long felt need in the field of lighting devices to provide an aesthetically pleasing lamp that has selectively alterable components and that possessed enhanced appeal stemming from the concealment of electrical wires used to provide power to the light source.

### SUMMARY OF THE INVENTION

The present invention utilizes automobile components to form the vertical structure, i.e. “body” of a lighting device. More specifically, crank shafts, engine heads, cam shafts pistons, engine blocks, etc. from automobiles are employed as the body of the lighting device wherein one end is interconnected to a base and the other end provides a location for the interconnection of a light fixture that includes a light bulb and, preferably, a harp for the interconnection of a shade. It is contemplated that other features may be added to the crank shaft, such as connecting rod and piston arms, or reproductions thereof, that are selectively adjustable to provide a dynamic light fixture. In addition, an end of the connecting rod that is not interconnected to the body of the lamp may be adapted to secure other items, such as candles, other light sources or shelves. One skilled in the art will appreciate that light fixtures of this type, since they are aesthetically pleasing in their own right are more desirable due to their ability to be dynamically altered.

It is another aspect of the present invention to provide a dynamic light fixture as contemplated herein that is utilized as a chandelier or wall sconce. That is, one skilled in the art will appreciate that one end of the automobile component may be associated with a ceiling of a room to create a mounting for a light source, a plurality of light sources, a fan, etc. The selectively alterable members that are interconnected to the body of some embodiments of the lighting device would then be adapted to secure additional lighting fixtures to form a chandelier.

It is another aspect of the present invention to provide furniture that utilizes vehicle components. More specifically, one skilled in the art will appreciate that crank shafts or other automobile componentry, may be used at the legs of a table or otherwise embodied into furniture to provide aesthetically pleasing and/or selectively alterable furniture. It is contemplated that the automobile table theme may be extended wherein the top of the table is an automobile component as well, such as a hood. The table legs, i.e the selectively alterable portions, may also be fitted with shelves to be used as drink and/or snack holders.

It is another aspect of the present invention to provide light fixtures or furniture that are aesthetically pleasing. More specifically, embodiments of the present invention employ crank shafts that have been manually polished or plated with nickel or chrome to add to their light reflectivity and their aesthetic value.

It is another aspect of the present invention to provide a light fixture with a customized base. More specifically, as indicated above, one end of the crankshaft is generally interconnected to a base for engagement on a flat surface, such as a desk or a shelf. It is envisioned that the base be formed in any shape and of any material, such as wood, marble, granite, steel, etc., and may include features such as gears or other items associated with automobiles. Further, the base may include logos or plaques associated with the owner of the lamp or the automobile from which the automobile component originates.

It is another aspect of the present invention to increase the aesthetic value of the lamp by concealing the wires associated with the power source that energizes the light bulb. More specifically, embodiments of the present invention employ a crankshaft with a bore therethrough such that wires associated with the power source are substantially hidden. One skilled in the art will appreciate that conduit may be required to further hide wires, which will be more apparent upon review of the figures. Alternatively, embodiments of the present invention utilize an externally routed power cord that is enclosed within a preferably metallic sheath and positioned away from the body of the lamp. The external sheath may be visually appealing so that one will believe that the external sheath is associated with the other body components that are used to fashion the lighting device. Although the use of power cords has been described herein, one skilled in the art will appreciate that battery power sources may be employed within the body of the lamp such that a wireless light fixture is provided that utilizes a crankshaft or other automobile component.

It is still yet another aspect of the present invention to provide a light fixture that utilizes brackets to interconnect the crankshaft or other automobile component to the base. More specifically, the base is generally comprised of a different material than the crank shaft wherein welding is not possible or feasible. Thus, brackets are used to securely interconnect the crankshaft to the base. Furthermore, one skilled in the art will appreciate that brackets may be required when interconnecting the automobile component to a ceiling, wall, table top, etc.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated herein and constitute a part of the specification, illustrate embodiments of the invention together with the general description of the invention given above and the detailed description of the drawings given below serve to explain the principles of these embodiments. However, the invention is not intended to be limited by only the embodiments provided here in the drawings as appreciated by one skilled in the art.

FIG. 1 is a perspective view of a lighting device of one embodiment of the present invention;

FIG. 2 is a front elevation view of the embodiment of the present invention shown in FIG. 1;

FIG. 3 is a left elevation view of the embodiment of the present invention shown in FIG. 1;

FIG. 4 is a rear elevation view of the embodiment of the present invention shown in FIG. 1;

FIG. 5 is a right elevation view of the embodiment shown in FIG. 1;

FIG. 6 is perspective view of the embodiment of the present invention shown in FIG. 1 with a shade removed for clarity;

FIG. 7 is a perspective view of a lighting device of another embodiment of the present invention;

FIG. 8 is a front elevation view of the embodiment of the present invention shown in FIG. 7;

FIG. 9 is a left elevation view of the embodiment of the present invention shown in FIG. 7;

FIG. 10 is a rear elevation view of the embodiment of the present invention shown in FIG. 7;

FIG. 11 is a right elevation view of the embodiment shown in FIG. 7;

FIG. 12 is perspective view of the embodiment of the present invention shown in FIG. 7 with a shade removed for clarity;

FIG. 13 is a perspective view of a lighting device of another embodiment of the present invention;

FIG. 14 is a front elevation view of the embodiment of the present invention shown in FIG. 13;

FIG. 15 is a left elevation view of the embodiment of the present invention shown in FIG. 13;

FIG. 16 is a rear elevation view of the embodiment of the present invention shown in FIG. 13;

FIG. 17 is a right elevation view of the embodiment shown in FIG. 1;

FIG. 18 is perspective view of the embodiment of the present invention shown in FIG. 13 with a shade removed for clarity;

FIG. 19 is a perspective view of a lighting device of another embodiment of the present invention;

FIG. 20 is a front elevation view of the embodiment of the present invention shown in FIG. 19;

FIG. 21 is a left elevation view of the embodiment of the present invention shown in FIG. 19;

FIG. 22 is a rear elevation view of the embodiment of the present invention shown in FIG. 19;

FIG. 23 is a right elevation view of the embodiment shown in FIG. 19;

FIG. 24 is perspective view of the embodiment of the present invention shown in FIG. 19 with a shade removed for clarity;

FIG. 25 is a perspective view of a lighting device of another embodiment of the present invention;

FIG. 26 is a front elevation view of the embodiment of the present invention shown in FIG. 25;

FIG. 27 is a left elevation view of the embodiment of the present invention shown in FIG. 25;

FIG. 28 is a rear elevation view of the embodiment of the present invention shown in FIG. 25;

FIG. 29 is a right elevation view of the embodiment shown in FIG. 25;

FIG. 30 is perspective view of the embodiment of the present invention shown in FIG. 25 with a shade removed for clarity;

FIG. 31 is a perspective view of a lighting device of another embodiment of the present invention;

FIG. 32 is a front elevation view of the embodiment of the present invention shown in FIG. 31;

FIG. 33 is a left elevation view of the embodiment of the present invention shown in FIG. 31;

FIG. 34 is a rear elevation view of the embodiment of the present invention shown in FIG. 31;

FIG. 35 is a right elevation view of the embodiment shown in FIG. 31; and

FIG. 36 is perspective view of the embodiment of the present invention shown in FIG. 31 with a shade removed for clarity.

To assist in the understanding of the present invention the following list of components and associated numbering found in the drawings is provided herein.

| # | Component |
|---|---|
| 2 | Lighting device |
| 6 | Shade |
| 10 | Automobile component |
| 14 | Base |
| 18 | Cord |
| 20 | Lighting component |
| 24 | Conduit |
| 28 | Arm |
| 32 | Support |

It should be understood that the drawing are not necessarily to scale. In certain instances, details that are not necessary for the understanding of the invention or that render other details difficult to perceive have been omitted. It should be understood, of course, that the invention is not necessarily limited to the particular embodiments illustrated herein.

### DETAILED DESCRIPTION

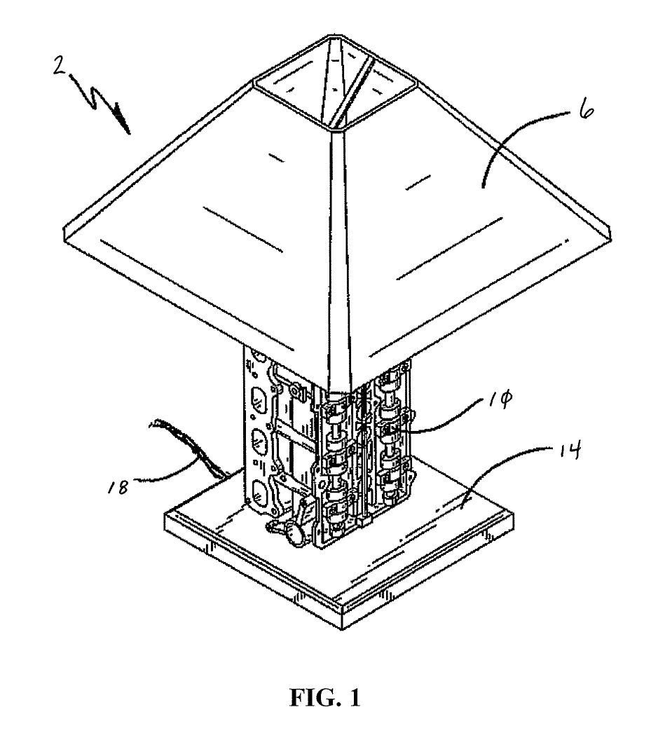

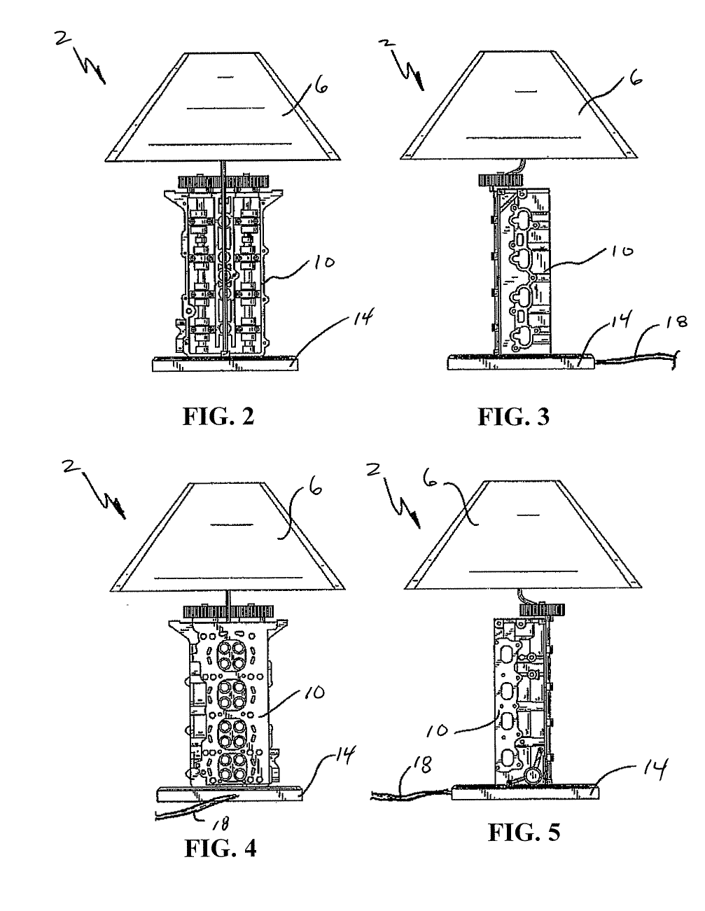

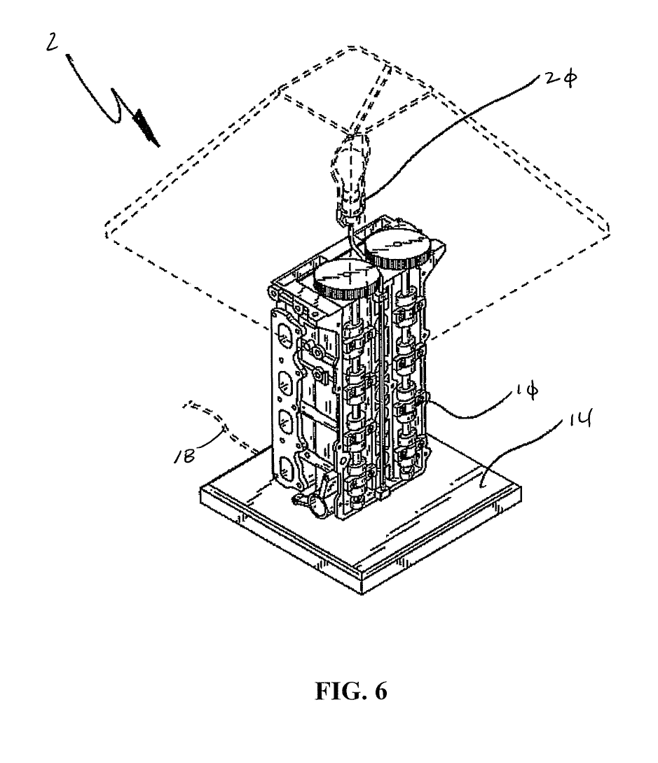

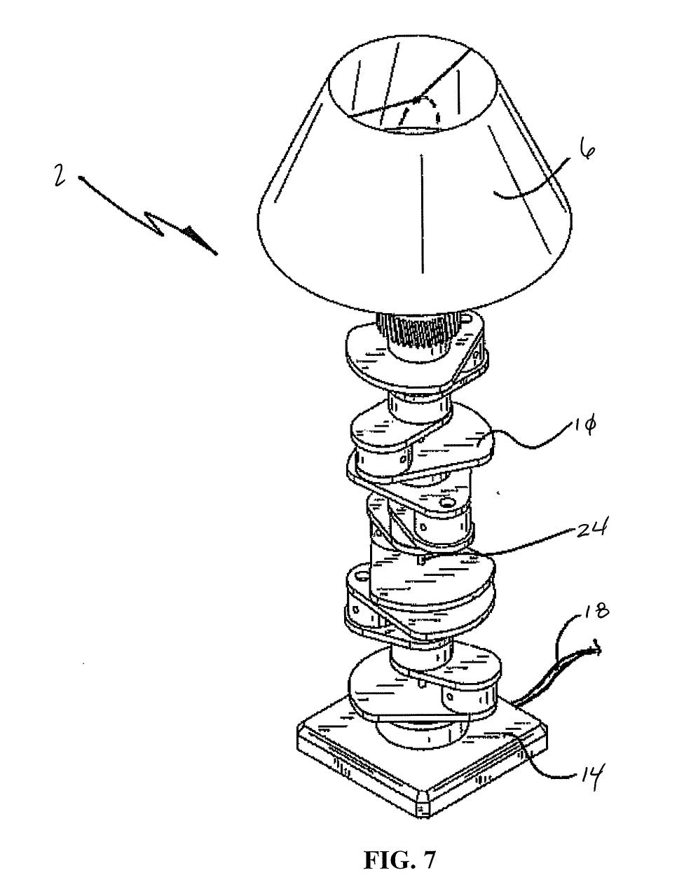

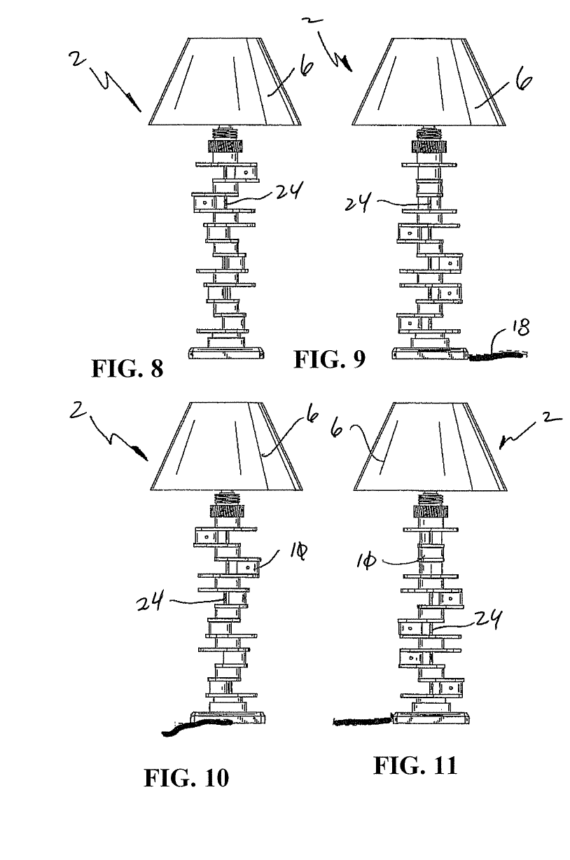

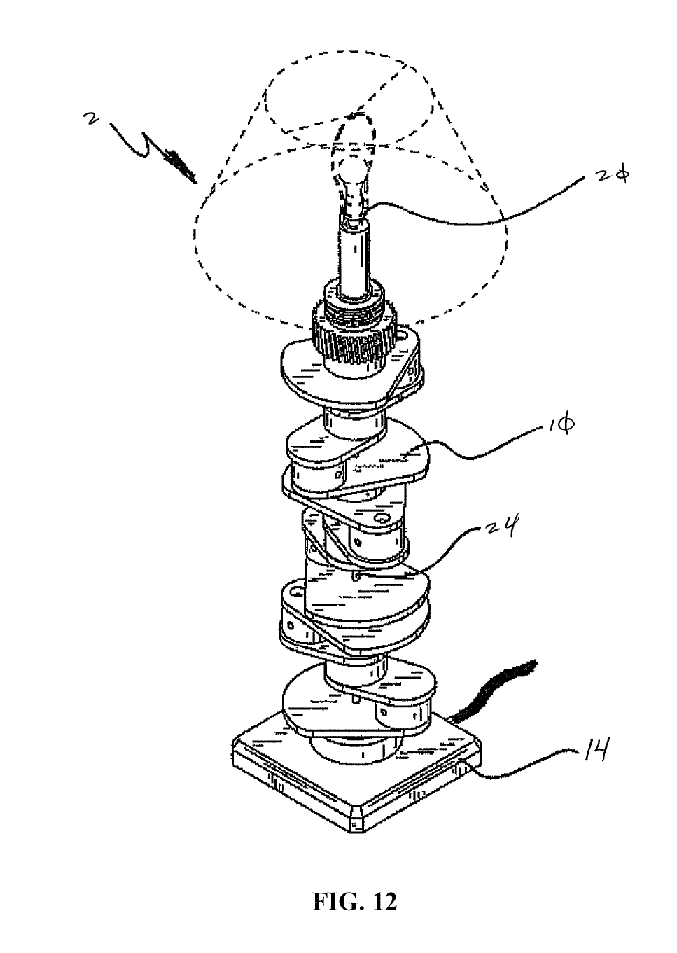

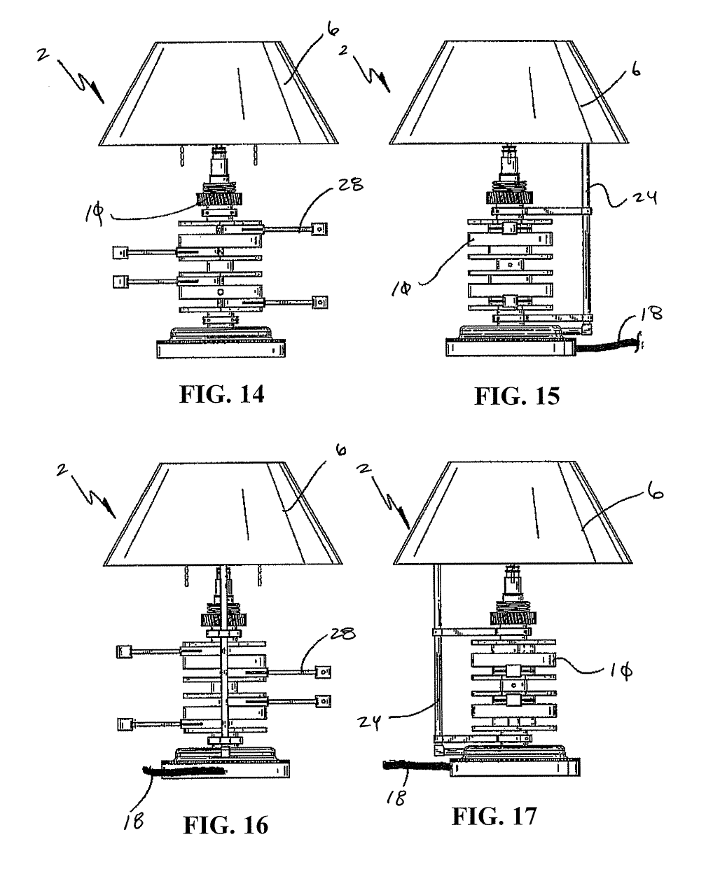

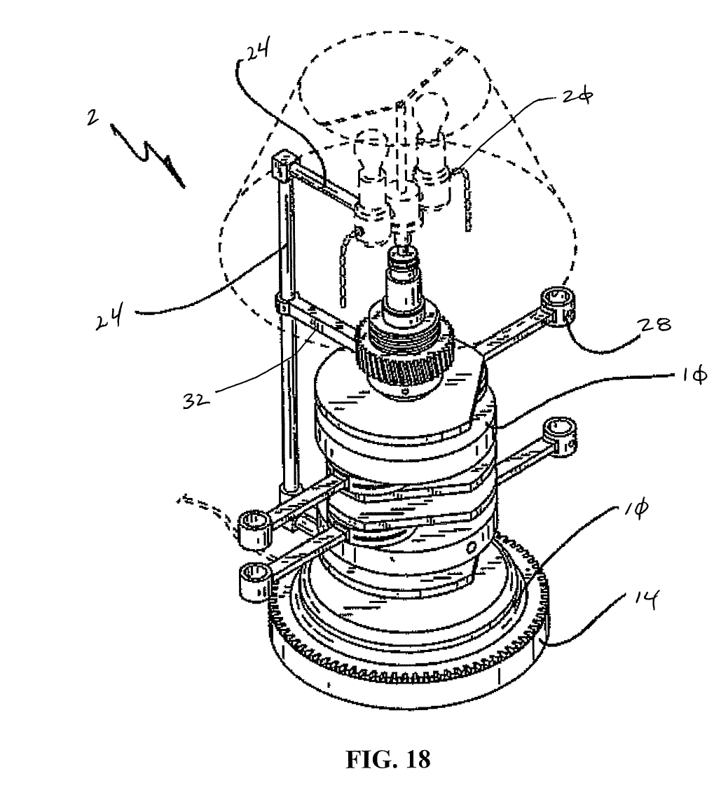

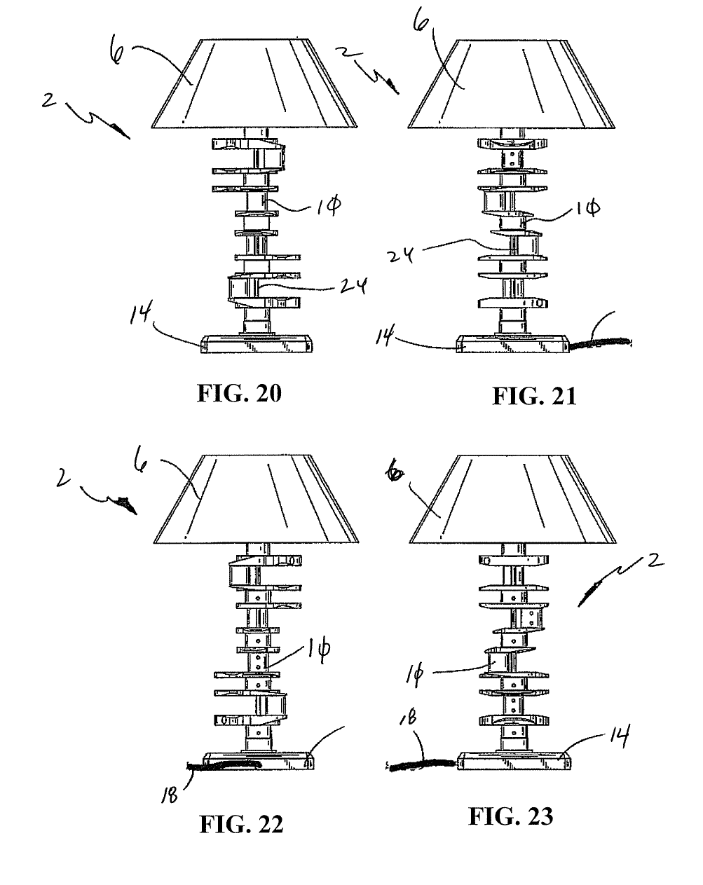

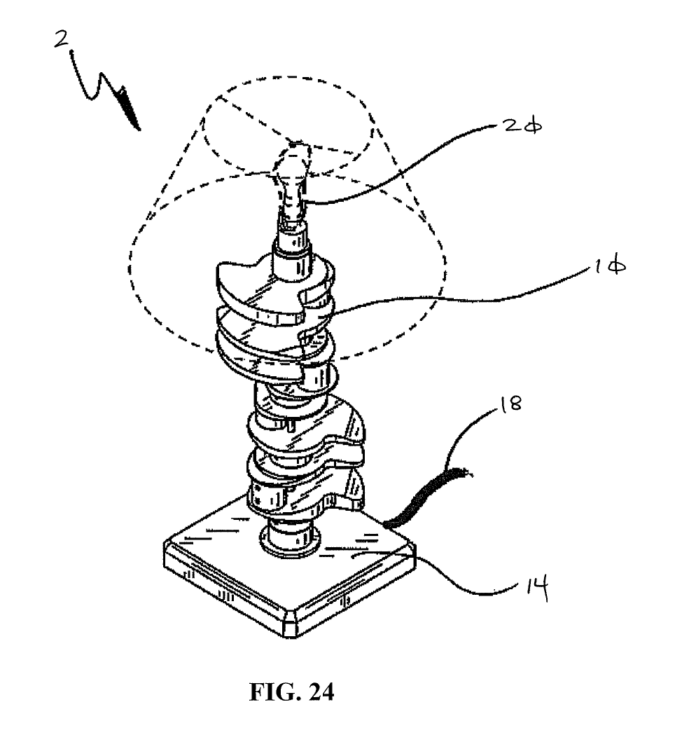

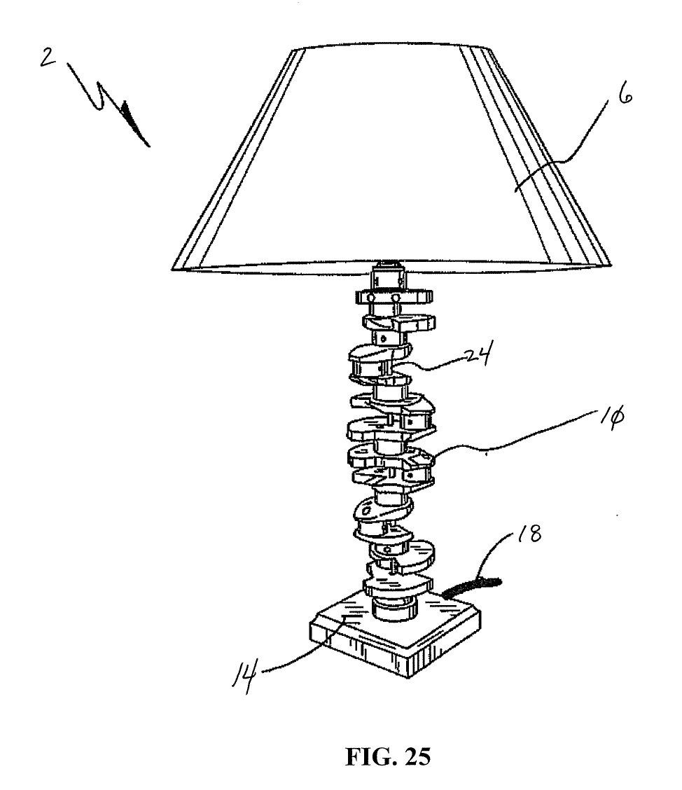

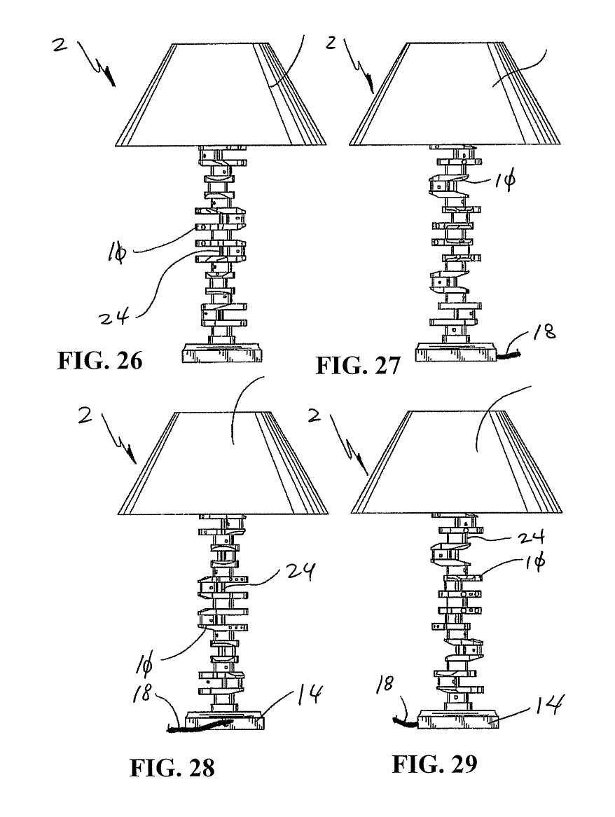

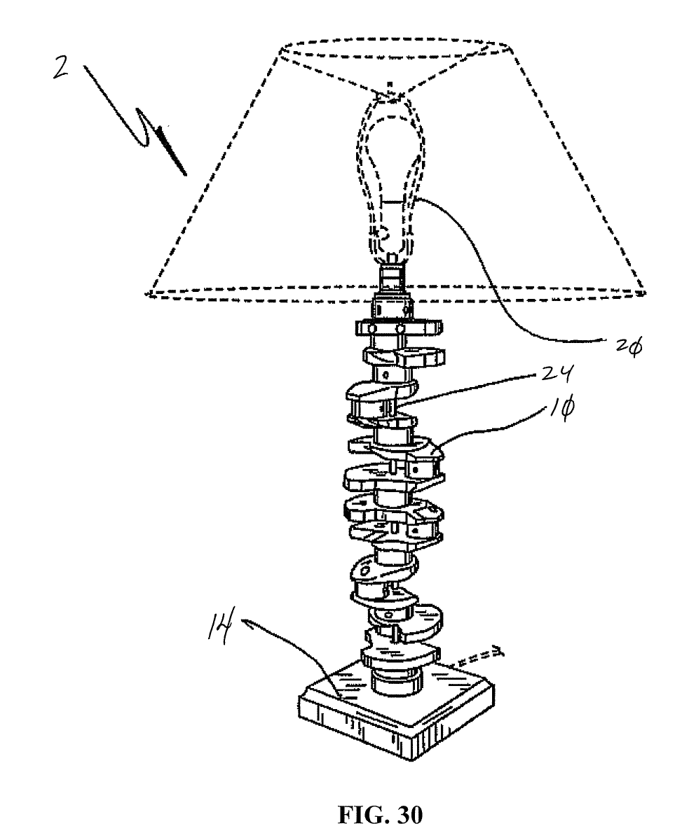

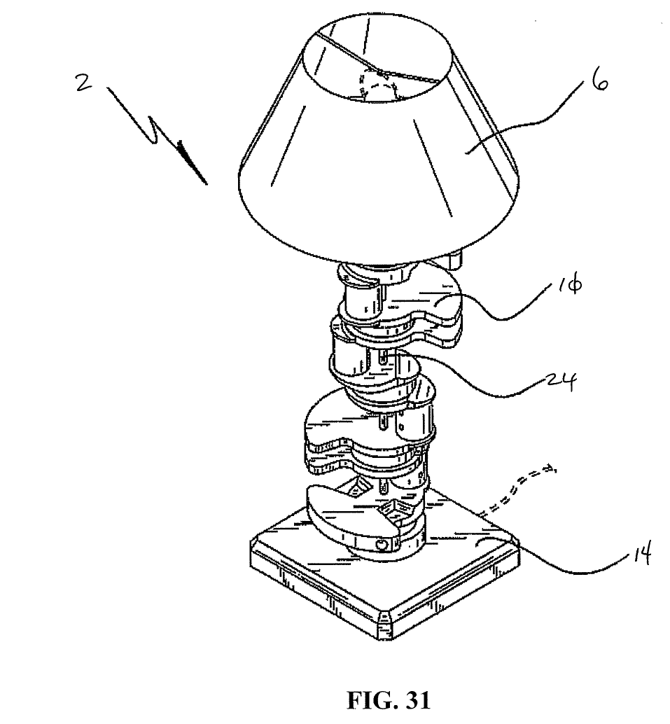

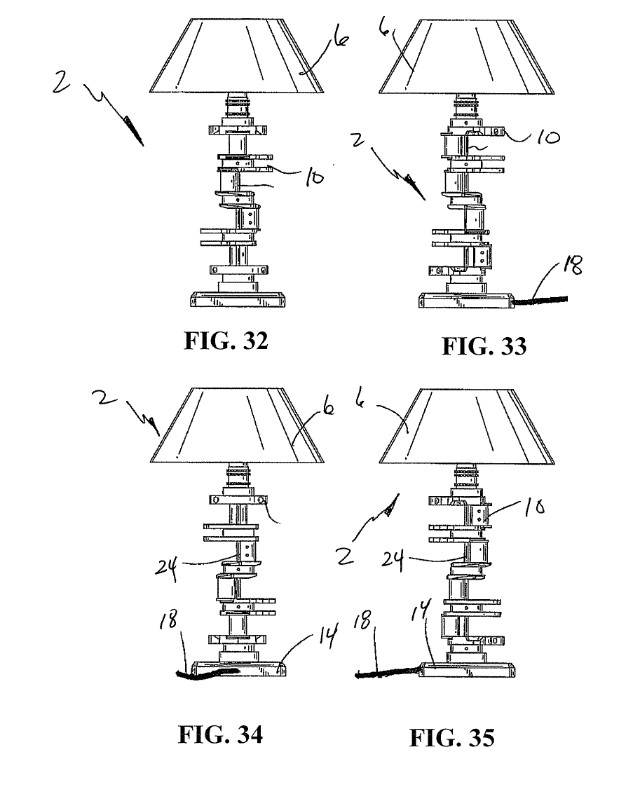

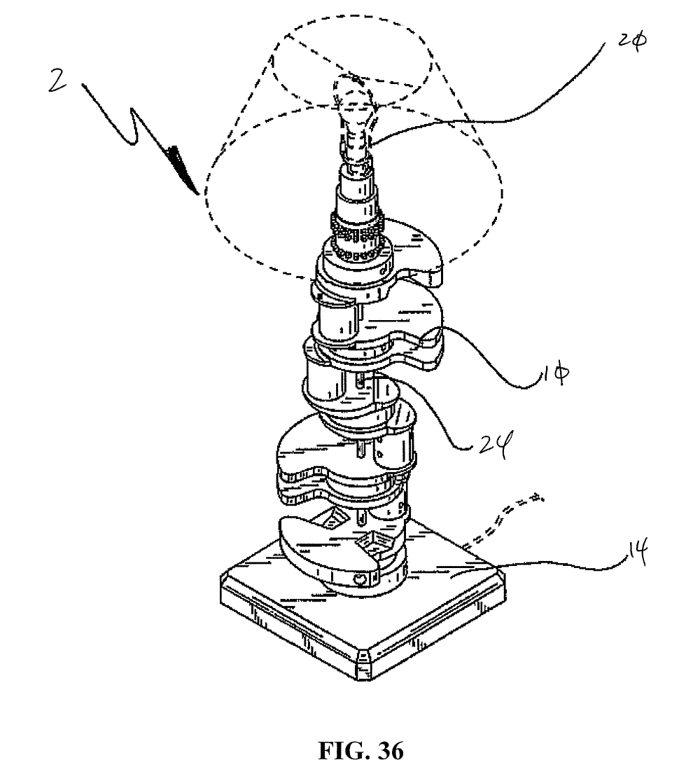

Referring now to FIGS. 1-36, a lighting device 2 of one embodiment of the present invention is shown. More specifically, lighting devices 2 as contemplated herein include a centralized body comprised of an automobile component 10 interconnected on one end to a base 14 and on another end to a lighting fixture 20 commonly known in the art. The lighting fixture 20 is also adapted to secure a shade 6. One skilled in the art should appreciate that a banker's lampshade may be employed without departing from the scope of the invention. The source of power to the light may be batteries, or more commonly, a cord 18 that provides power from a power source. The electrical wires that are associated with the light fixture are hidden in embodiments of the present invention thereby making the lighting device 2 more aesthetically pleasing.

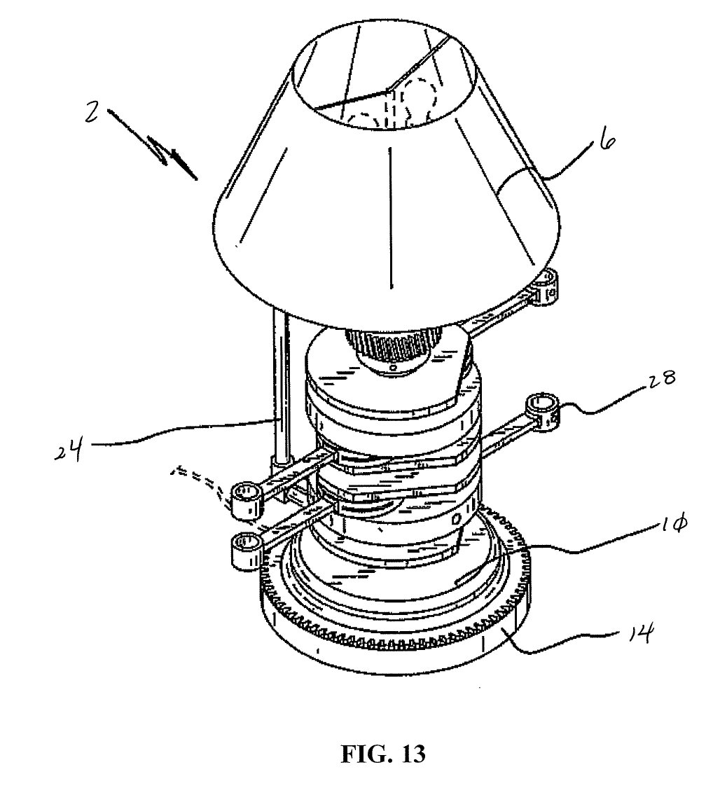

Referring now specifically to FIGS. 13-18, yet a method of concealing an electrical wire is shown. More specifically, often it is either mechanically not feasible or expensive to bore a hole through the automobile component 10. Thus embodiments of the present invention employ an exterior conduit 24 to house the electrical wires associated with the lighting devices 2. Preferably, the conduit 24 is fashioned in such a way that the viewer of the lighting device 2 would mentally associate the conduit 24 with the automobile component 10. This is done by preferably adding features to the conduit 24 to render it similar to the automobile component 10 and/or by treating its external surface to match that of the automobile component 10. It is also shown that other components such as a base 14 may be employed along with the automobile components shown.

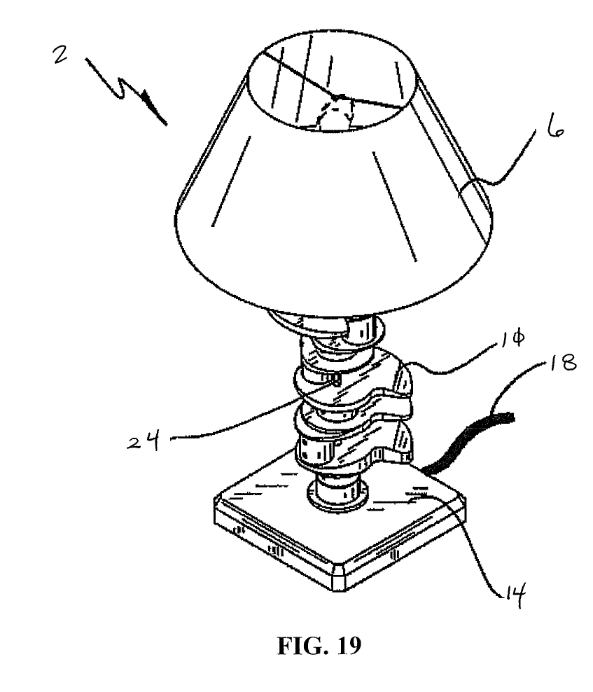

Referring now to FIGS. 19-24, embodiments of the present invention are shown that employ an internal conduit 24 for concealing the electrical wiring associated with the light fixture 26. More specifically, embodiments of the present invention use a conduit 24 that spans at least partially through the automobile component 10. Upon preparation of the automobile component 10 for assembly, a hole is drilled through the automobile component 10 that is adapted to receive the conduit 24 to define a channel for the routing of electrical wiring. By hiding the wiring, it has been found that the lighting device 2 is more aesthetically pleasing such that visually offensive wires or cables are hidden from view.

Referring back to FIGS. 13-18, another aspect of the present invention that enhances the aesthetic nature of the lighting device 2. More specifically, embodiments of the present invention include appendages, or arms 28, that allow the user to selectively alter the appearance of the lighting device 2. The arm 28 of some embodiments of the present invention rotatably interconnected to the automobile component 10. The arms 28 may be taken directly from an automobile or fabricated to look like connecting rods or rocker arms of an automobile. The arms 28 may be adapted to receive additional light bulbs or may include a shelf on an end thereof to provide storage for other items that may be associated with the lighting device 2, such as picture frames, etc. While connecting rods have been shown in the figures, one skilled in the art will appreciate that other selectively adjustable items may be incorporated into light to provide a lighting device body that is a living sculpture wherein the external appearance of the lighting device may be customizable at will.

Although table lamps have been shown in the figures that the selectively adjustable nature of embodiments of the present invention may be translated to other items. For example, it is envisioned that the automobile component 10 may be used in a chandelier or sconce wherein the end associated with the base 14 is interconnected to the ceiling or wall of a structure. The selectively adjustable arms 28 of some embodiments would then be adapted to secure additional lighting fixtures, for example, and be able to be reoriented depending on the user's lighting needs. In addition, it is also contemplated that an automobile component 10 with or without selectively adjustable members may be used in conjunction with a table wherein the automobile component 10 is interconnected to a table top, thereby providing the legs or the central core thereof. One skilled in the art will also appreciate that additional light fixtures 20 may be incorporated into the automobile component 10 and/or the movable arms 28.

Referring now to FIGS. 1-36, one method of making the invention is provided. More specifically, once a suitable automobile component 10 is found, it is cleaned by removing all grease and rust. Next, depending on the method of concealing electrical wires associated with the lamp, a bore is created generally within the center of the automobile component 10 generally running parallel to the center line thereof. The automobile component 10 then goes through a processes of hand polishing, vibratory tumbling and, in some instances, repolishing. The polished piece is then protected via clear powder coat. Additional metal conduit may be added to further conceal the wire that is associated with the lighting fixture 20. Next, the lighting fixture 20 is integrated onto one end of the automobile component 10 and the associated wires are placed within the conduit. The base 14 is then interconnected to the other end of the automobile component 10 and the electrical wires are then threaded through the base 14. In some instances a harp and associated shade 6 is then incorporated onto the light fixture 20 to yield a finished product. Some embodiments of the present invention also include at least one selectively adjustable component 28 interconnected to the automobile component 10. The adjustable component 28 may be interconnected at any time or be interconnected by the purchaser of the lighting device 2. As described above, the boring step may be omitted wherein an external conduit is employed thereby decreasing the time of production.

While various embodiments of the present invention have been described in detail, it is apparent that modifications and alterations of those embodiments will occur to those skilled in the art. However, it is expressly understood that such modifications and alterations are within the scope and sphere of the present invention, set forth in the following claims.

What is claimed is:

1. A selectively alterable lighting device, comprising:
an automobile component having a first end and a second end;
a selectively adjustable component having a first position of use and a second position of use interconnected to said automobile component;
a lighting fixture interconnected to said first end; and
a conduit interconnected to said lighting fixture that is adapted to internally receive an electrical conductor, wherein the electrical conductor is substantially concealed.

2. The device of claim 1, further comprising a base interconnected to said second end.

3. The device of claim 1, wherein said automobile component is a crankshaft.

4. The device of claim 1, further comprising a lamp shade operatively associated with said lighting fixture.

5. The device of claim 1, wherein said conduit is situated generally within said automobile component and is substantially hidden.

6. The device of claim 1, wherein said conduit is situated outside said automobile component.

7. The device of claim 1, wherein said lighting fixture is adapted to receive at least two light bulbs.

8. The device of claim 1, wherein said second end is adapted to be interconnected to a ceiling of a structure.

9. A selectively alterable furniture, comprising:
an automobile component having a first end and a second end;
a selectively movable component having a first position of use and a second position of use interconnected to said automobile component;
wherein said first end is adapted for operable association with at least one of a lighting fixture and a table top; and
wherein said second end is adapted for operable association with at least one of a ceiling, a base, a table leg, and a floor.

10. The alterable furniture of claim 9, wherein said selectively movable component is adapted to receive at least one of a shelf, a candle, a second lighting fixture, and a means for lighting.

11. The alterable furniture of claim 9 further comprising a conduit interconnected to said lighting fixture that is adapted to receive an electrical conductor.

12. A method of making a selectively alterable lighting device, comprising:
providing an automobile component;
securing the automobile component in a predetermined orientation;
drilling a bore through said automobile component;
interconnecting said automobile component to a base on one end and to a lighting fixture on another end
inserting an electrical component within said bore; and
rotatably interconnecting an arm to said automobile component.

13. The method of claim 12, further comprising polishing said automobile component.

14. The method of claim 12, further comprising cleaning said automobile component.

15. The method of claim 12 wherein said securing comprises interconnecting said automobile component to a base.
